(19) United States
(12) Patent Application Publication
(10) Pub. No.: US 2008/0056091 A1
(43) Pub. Date: Mar. 6, 2008

(54) MULTIVALUED INFORMATION RECORDING REPRODUCING METHOD

(75) Inventors: Masakuni Yamamoto, Yamato-shi (JP); Jun Sumioka, Kawasaki-shi (JP); Kaoru Okamoto, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/836,967

(22) Filed: Aug. 10, 2007

(30) Foreign Application Priority Data
Sep. 5, 2006 (JP) 2006-240259

(51) Int. Cl. G11B 20/14

(52) U.S. Cl. 369/59.24

(57) ABSTRACT

A method of recording multivalued information by writing, by using a photo spot, an information pit on a virtual cell that is set on a track of an optical information recording medium, while changing a width of the information pit in the direction of the track, and of reproducing the multivalued information by detecting a level of the multistep reproduced signal from the information pit, includes: recording different pieces of multivalued information in a learning area of the optical information recording medium on a unit cell (predetermined number of cells) basis; sampling the reproduced signals of the multivalued information on the unit cell basis by using the photo spot; storing the reproduced signals in the sampled learning area on the unit cell basis; recording the multivalued information in a user data area of the optical information recording medium; sampling, by using the photo spots, the reproduced signals from the multivalued information recorded on the user data area; and reproducing the multivalued information in the user data area by comparing the reproducing signal of the learning area and the reproduced signal of the user data area.

### BACKGROUND OF THE INVENTION

1. Field of the Invention

The present invention relates to recording and reproducing multivalued information on and from an information recording medium such as an optical disk, and more specifically to a data train in a learning data area.

2. Description of the Related Art

The optical memory industry has been growing. The optical memories have been developed from a CD and a DVD dedicated to reproducing up to those of a write-once type made of a metal film and a dye recording material, as well as and also those of a rewrite type made of a magneto-optical material and a phase change material, with application thereof also growing from consumer use purposes to outside memories for a computer. Research and development has also advanced to make storage capacities of the optical memories denser. For techniques for microminitualizing photo spots used for recording and reproducing information, the wavelengths of a light source is shifting from red (650 nm) to bluish-purple (450 nm).

The numerical aperture of an object lens has also been increased from 0.6 or 0.65 to 0.85. A more efficient technique for multivalued recording and reproducing using the photo spots in the same size has also been proposed.

For example, the inventor of the present application has proposed a technique relating to multivalued recording and reproducing in Japanese Patent Application Laid-Open No. H05-128530. The technique disclosed in this publication records multivalued information on information tracks of an optical information recording medium in accordance with combinations of a width in the direction of a track of information pits and an amount of shift in the direction of the track against the photo spot for reproducing. The technique reproduces the multivalued information by using correlation between previously learned detecting signals and detecting signals obtained from the photo spots when it reproduces the multivalued recorded information pits.

Results from multivalued recording and reproducing have been introduced in ISOM2003 (Write-onceDisks for Multi-level Optical Recording: Proceedings Fr-Po-04), which is an international academic circle in research in the field of optical disks. Specifically, a bluish-purple light source (405 nm) and an optical system of NA0.65 are used. An area for recording an information pit (hereinafter referred to as a cell) is virtually provided for an optical disk with a track pitch of 0.46 μm. The width of the area in the direction of a track is 0.26 μm. Multivalued recording and reproducing in eight levels was performed.

In Japanese Patent Application No. 2005-047198, the inventor of the present application has proposed a technique for making storage capacities denser up to around 30 Gbit/inch² in order to adapt to the multivalued method disclosed in ISOM2003 by microminitualizing the photo spots with a bluish-purple light source (405 nm) and an optical system of NA0.85.

In the above publication, for selection of the information pits in eight levels, a width in the direction of a track of a cell (in the direction of A in the figure) is divided into 16 parts as shown in FIG. 15 (16 channel bits) with the level 0 being for recording no information bit. The level 1 is a width of two channel bits, the level 2 is a width of four channel bits, the level 3 is a width of six channel bits and the level 4 is a width of eight channel bits. The level 5 is a width of ten channel bits, the level 6 is a width of twelve channel bits and the level 7 is a width of 14 channel bits.

FIG. 16 is a diagram illustrating a case in which random information bits are recorded on tracks on an optical disk, illustrating relationship between photo spots.

For larger storage capacity, the size of a cell needs to be reduced. If the size of a cell is decreased, two to three pieces of information bits are included in a photo sport as shown in FIG. 16. In FIG. 16, an arrow A shows the direction of the track and areas separated by dashed lines show virtually provided cells. The figure shows a track 11 on an optical disk, a random information bit 12, and a photo spot 13.

It is assumed that the width of a cell is 0.2 μm for the size of the photo spot about 0.405 μm. With those sizes, the present invention can increase the surface density of 19.5 Gbit/inch² in the conventional method with binary level (for example, 1-7PP modulation, 2T=139 nm) by a factor of about 1.5.

Now, results of an optical simulation performed to know the states of the reproduced signal provided by this technique will be described. FIG. 17 shows parameters used in the optical simulation. The track pitch is 0.32 μm, the size of the photo spot is 0.405 μm (wavelength 405 nm, numerical aperture of an object lens: NA0.85) and the size of the cell is 0.2 μm. The information pits have the shapes as shown in FIG. 18 for respective levels shown in FIG. 15. The level 0 is for recording no information pit.

FIG. 19 shows a result of calculating a reproduced signal (reflected light amount) when combinations of eight kinds of levels are provided to consecutive three cells in order (there are 8×8×8 512 combination in total) and a photo spot is moved from the first central cell (preceding cell) to the third central cell (following cell). The lower drawing in FIG. 19 shows eight combinations of levels of three cells from (0, 1, 6) to (7, 1, 6) for example (those other than the three levels are assumed at the level 0).

The places of the three solid lines shown in the figure indicates respective reproduced signals (cell central values) provided when photo spots are at the central cells. It is apparent that the cell central value of the central cell corresponds to the level “1” in these conditions, but the cell central value has variations so as not to take the same value when the level at the left cell changes from “0” to “7”. That is a result from an inter-code interference.

FIG. 20 shows distribution amplitudes of respective reproduced signals in all the combinations of levels to be recorded in the consecutive three cells with the lateral axis showing levels of the central cells (here, the longitudinal axis relatively shows amplitudes of the reproduced signals).

The distributions from A to H in the figure correspond to the level 0 to the level 7. As it is apparent from FIG. 20, many distributions of reproduced signals at adjacent levels are overlapped, making it difficult to identify the level by using a fixed threshold in such a state.

Then, a method for increasing the degree of separation of the reproduced signals by performing signal processing on the reproduced signal like waveform equalization is taken in general. For example, waveform equalization of three taps is calculated as shown in FIG. 21.

Here, T is a moving time required for moving the photo spot from a cell center to an adjacent cell center and “a” is a coefficient. It is calculated by assuming that a=−V1/(1+V1), V1=0.237 (V1: an amplitude value in an adjacent cell for an isolated waveform of the amplitude 1).

FIG. 22 shows the results (the longitudinal axis also relatively shows amplitudes of the reproduced signals here). A′ to H′ corresponds to seven distributions from the level 0 to the level 7, respectively. It is apparent from FIG. 22 that a fixed threshold can separate respective distributions.

FIG. 23 shows the results shown in FIG. 22 by plotting the number of samples (1 to 512) on the lateral axis. That is, FIG. 23 is plotted by the program shown below if the levels of the three consecutive cells are x, y and z and their reproduced signals are S (x, y, z).

```
For x=0 to 7
  For z=0 to 7
    For y=0 to 7
    Plot S (x, y, z)
    Next
  Next
Next
```

The figure is obtained by calculation. The figure shows affection caused by the inter-code interference from preceding and following cells and nonlinearity affection caused by the fact that the photo spot is Gaussian and uneven. In the actual recording/reproducing system, affection caused by the heat interference by heat storage in the medium and affection caused by individual differences in the medium sensitivity are obtained as a result of the learning table.

The present invention is for enabling denser storage capacities by shortening the cell length to 160 nm, for example, as to be detailed later. FIG. 24 shows reproduced signal values of the central cells when the consecutive three cells are considered as a unit, the combinations of the cells are changed in order so that 512 kinds of patterns (preceding cell×central cell×following cell=8×8×8) are recorded on the optical disk, and they are reproduced by plotting the reproduced signal values as in FIG. 23. The learning table in FIG. 24 has larger differences from the ideal table of FIG. 23 that is obtained by the calculation.

By applying a general reproducing algorithm for multivalued recording, a cell central value of each cell is determined by using a fixed threshold on the basis of reproduced signals of random data and the level is provisionary discriminated first. A fixed threshold is selected in a manner of averaging values of the learning table of the central cell that has the values at the same level and making the average value as a reference value of each level. Then, making a median value of the reference values at the adjacent levels the threshold.

Then, eight reference values (from the level 0 to the level 7) complying with the reproduced value of the central cell are extracted from the learning table according to the provisionally discriminated values of preceding and following cells. Next, the eight reference values are compared with the reproduced value of the central cell, and the level of the reference value closest to the reproduced value is discriminated anew as a reproduced level.

Assuming that the levels of the preceding cell and the following cell are the level 3 and the level 5, respectively, as a result of provisional discrimination. In such a case, combinations of the levels of the preceding and following cells and the central cell of (3, 0, 5), (3, 1, 5), (3, 2, 5), (3, 3, 5), (3, 4, 5), (3, 5, 5), (3, 6, 5), (3, 7, 5) are extracted from the learning table. The values are placed almost on a line drawn orthogonal to the lateral axis according to the levels of the preceding and following cells in the learning table.

If the learning table shown in FIG. 24 is incorrect, reproduction accuracy decreases. From actual reproduction performed with the learning table in FIG. 24, a desired error rate cannot be obtained.

FIGS. 25 and 26 show reproduced signals when a trigger mark and random data are recorded or reproduced for the cell of the length of 200 nm and 160 nm, respectively. It is apparent from the figures that affection of the inter-code interference increases as the cell length is reduced from 200 nm to 160 nm.

FIG. 27 shows coefficients for waveform equalization that is optimized for the respective cell lengths of 200 nm and 160 nm. Here, the coefficients are considered for five taps. As the cell length changes from 200 nm to 160 nm, the coefficient of ±2 increases by one digit from 0.01 to 0.12. That is, it is apparent that not only influence caused by the inter-code interference from the preceding and following cells of the central cell but also influence from the further preceding and following cells are big in the case of the cell length 160 nm.

If a bluish-purple light source (405 nm) and an optical system of NA0.85 are used, the photo spot is microminitualized, and the cell length is assumed to be 160 nm, for example, to apply for the multivalued method of the prior application (Japanese Patent Application No. 2005-047198), then the storage capacity can be made denser around to 36 Gbit/inch².

If the levels of the cells are changed in order by N cell unit (here, N is three) described in FIG. 24 and recorded, and a learning table is created from the reproduced signals that are obtained by reproducing the record, then an incorrect learning table is created, worsening the reproduction accuracy.

This is because, as described from FIG. 25 to FIG. 27, with the cell length of 160 nm or less, there is influence caused by the inter-code interference for each two cells of the preceding and following cells as well as for each one of the preceding and following cells for the central cell.

If the influence is removed to enable correct learning, learning data with 32,768 combinations (8 to the 5-th power) needs to be recorded or reproduced by a unit of five cells. Compared with the learning data of 200 nm with 512 combinations by a unit of three cells, the above case has an extremely larger scale and a larger learning area on a medium. The above case further has a problem in that it has a longer learning time with accordingly complicated reproducing algorithm.

### SUMMARY OF THE INVENTION

It is an aspect of the present invention to provide a multivalued information recording reproducing method of enabling highly accurate multivalued reproduction without complicating the learning method even if the storage capacity is made denser with the cell length of 160 nm or less by further improving the conventional techniques.

Specifically, a multivalued information recording reproducing method of recording multivalued information by writing, by using a photo spot, an information pit on a virtual cell that is set on a track of an optical information recording medium, while changing a width of the information pit in the direction of the track, and of reproducing the multivalued information by detecting a level of the multistep reproduced signal from the information pit, comprising the steps of: recording different pieces of multivalued information in a learning area of the optical information recording medium on a unit cell basis, wherein the unit cell includes a predetermined number of cells and a predetermined information pit is recorded or otherwise none is recorded in cells at both ends of the predetermined number of cells; sampling the reproduced signals of the multivalued information on the unit cell basis by using the photo spot; storing the reproduced signals in the sampled learning area on the unit cell basis; recording the multivalued information in a user data area of the optical information recording medium; sampling, by using the photo spots, the reproduced signal from the multivalued information recorded on the user data area; and reproducing the multivalued information in the user data area by comparing the reproducing signal of the learning area and the reproduced signal of the user data area.

Further features of the present invention will become apparent from the following description of exemplary embodiments with reference to the attached drawings.

### BRIEF DESCRIPTION OF THE DRAWINGS

FIG. 1 is a block diagram illustrating an embodiment of a multivalued information recording reproducing device according to the present invention.

FIG. 2 is a diagram illustrating an example of a learning table obtained by a learning method according to the present invention.

FIG. 3 is a diagram for illustrating physical relationship between preceding and following cells and a photo spot when an inter-cell value is sampled.

FIG. 4 is a diagram for illustrating physical relationship between preceding and following cells and a photo spot when an inter-cell value is sampled.

FIGS. 5A and 5B are diagrams illustrating simulation results that show histograms of reproduced signal levels of a cell central value before and after waveform equalization is performed when multivalued data of eighth levels are reproduced.

FIGS. 6A and 6B are diagrams illustrating simulation results that show histograms of reproduced signal levels of an inter-cell value before and after the waveform equalization is performed.

FIG. 7 is a diagram illustrating combinations of multivalued levels of cells arranged left and right to the inter-cell value.

FIG. 8 is a diagram for illustrating a method for discriminating multivalued data in a multivalued data discriminating circuit.

FIGS. 9A and 9B are diagrams illustrating learning tables used in discriminating multivalued data, with FIG. 9A illustrating a cell central value learning table and FIG. 9B illustrating an inter-cell value learning table.

FIG. 10 is a diagram for illustrating a method for deciding a candidate value for a subject cell by using a cell central value learning table of a cell central value discriminating unit in FIG. 8.

FIG. 11 is a diagram for illustrating a method for deciding a candidate value for a subject cell by using an inter-cell value learning table by an inter-cell value discriminating unit in FIG. 8.

FIG. 12 is a diagram for illustrating an algorithm for a final value discriminating unit in FIG. 8.

FIG. 13 is a diagram illustrating an algorithm for discriminating a multivalued level of the subject cell in FIG. 12.

FIG. 14 is a diagram for illustrating an algorithm for correcting the multivalued level of the precedence cell in FIG. 12.

FIG. 15 is a diagram for illustrating a multivalued mark.

FIG. 16 is a diagram illustrating a random information pit and a photo spot recorded on an information track.

FIG. 17 is a diagram for illustrating parameters for optical simulation.

FIG. 18 is a diagram illustrating a shape of an information pit given in the optical simulation.

FIG. 19 is a diagram illustrating a calculation result from the optical simulation, which is a diagram for illustrating a reproduced signal for an information pit written in consecutive three cells.

FIG. 20 is a diagram illustrating an amplitude distribution of the cell central values (lateral axis shows the level of the central cell).

FIG. 21 is a diagram for illustrating the waveform equalization of three taps.

FIG. 22 is a diagram illustrating amplitude distribution of the cell central values after the waveform equalization in FIG. 21.

FIG. 23 is a diagram illustrating an ideal learning table obtained by calculation.

FIG. 24 is a diagram for illustrating the learning table obtained in a recording/reproducing experiment for the cell length 160 nm.

FIG. 25 is a diagram illustrating a reproduced signal of random data in a case where the cell length is 200 nm.

FIG. 26 is a diagram illustrating a reproduced signal of random data in a case where the cell length is 160 nm.

FIG. 27 is a diagram for illustrating a difference between equalizer coefficients due to the difference between the cell lengths.

### DESCRIPTION OF THE EMBODIMENTS

### Embodiments

Exemplary embodiments of the present invention will be described in detail in accordance with the accompanying drawings. First, when learning data is written, an information pit, which is determined in advance to average influence of inter-code interference, is recorded with cells at both ends of a unit cell as dummy cell data or nothing is recorded. Here, a unit is made of five cells.

Then, a reproduced signal of multivalued information for each cell is sampled with a photo spot, and they are stored as learning data on the unit cell basis.

When it is to be reproduced, the reproduced signal is sampled with the photo spot for the multivalued information recorded in the user data area, and the reproduced signals stored as learning data are compared with the reproduced signal in the user data area to reproduce the multivalued information in the user data area.

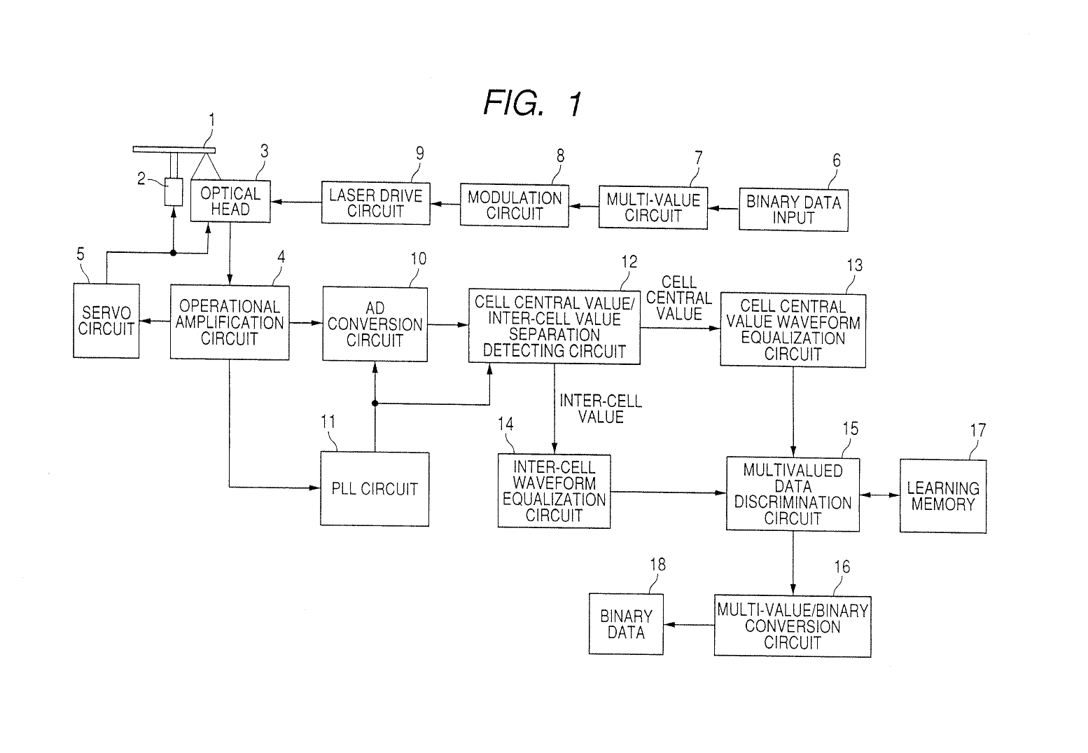

Now, an exemplary embodiment of the present invention will be described in detail with reference to the drawings. FIG. 1 is an outlined block diagram illustrating an embodiment of a multivalued information recording reproducing device according to the present invention. The figure shows an optical disk 1, which is an information recording medium with tracks arranged spirally or concentrically, and a spindle motor that rotationally drives the optical disk 1.

The figure shows an optical head 3 for recording or reproducing the multivalued information on or from the optical disk 1. The optical head 3 condenses laser light from a semiconductor laser of a light source and radiates a photo spot on the optical disk 1. The reflected light from the optical disk 1 of the photo spot is detected by a photo detector in the optical head 3 and sent to an operation amplifying circuit 4.

To describe the optical head 3, it is assumed that the wavelength λ of the light source (semiconductor laser) is 405 nm and the numerical aperture of the object lens NA is 0.85 as an example. Accordingly, approximately 405 nm is given as the value of the size of the photo spot. It is also assumed that the track pitch of the optical disk 1 is 0.32 μm and the cell length is 160 nm. In this case, the storage capacity can be made denser to around 36 Gbit/inch².

The size of the photo spot and the cell length are not limited to them, and the present invention can be used even if the inter-code interference for the central cell influences the two of the preceding cell and the following cell, i.e., even if the cell length is about 160 no or less. The photo spot is generally defined as a range up to 1/e² of the beam intensity, but in the present invention, it is considered that the beam in the range outside the 1/e² of the beam intensity of the photo spot may influence caused by the inter-code interference.

The multivalued information is recorded as cells are virtually provided by a certain interval on information track of the optical disk 1 as described in FIG. 16 and the width of the information pits (or an area of an information pit) are changed in each cell. The multivalued information with a plurality of levels can be obtained as amplitude of the reproduced signals from the information pit is divided into multisteps.

The operation amplifying circuit 4 detects a focus error signal/tracking error signal for controlling to scan the photo spot along a desired track of the optical disk 1 by processing a signal from the photo detector of the optical head 3. The servo circuit 5 performs focus control or tracking control by controlling a focus actuator/tracking actuator in the optical head 3 based on the signal. The servo circuit 4 performs rotation control on the optical disk 1 to the constant linear velocity or the angular velocity by controlling the spindle motor 2.

When the multivalued information is recorded on the optical disk 1, the binary data input 6 is converted to the multivalued data by the multivalue circuit 7 and the signal according to the multivalued data is output from the modulating circuit 8. In response to the signal, the laser driving circuit 9 drives a semiconductor laser in the optical head 3 and records a mark corresponding to the multivalued information on the track of the optical disk 1.

When the multivalued information is to be reproduced, the photo spot used for reproduction is radiated on the optical disk 1 from the optical head 3 and the photo detector receives the reflected light. The detected signal is subjected to signal processing at the operational amplifying circuit 4, the obtained signal is converted into a digital signal at an AD converting circuit 10, and the digital signal is separated into the cell central value and the inter-cell value by a cell central value/inter-cell value separation detecting circuit 12.

Those processings are performed by using the clock created by a PLL (phase-locked loop) circuit 11. The waveform equalization is performed on the cell central value separated by the cell central value/inter-cell value separation detecting circuit 12 by a cell central value waveform equalization circuit 13, and the waveform equalization is performed on the inter-cell value by an inter-cell value waveform equalization circuit 14. Then, a reference value of learning table data is read out from a learning memory 17, and the multivalued data discriminating circuit 15 discriminates multivalued level based on both of the values to be described later. Further, the data is converted into binary data by a multivalued-binary value converting circuit 16 and output as the binary value data output 18.

Now, a learning method according to the present invention will be described. The present invention is characterized by a learning method of recording the learning data in the optical disk 1. The learning data means data, which is previously stored in a learning data area, a predetermined area in the optical disk for creating a cell central value learning table or an inter-cell value learning table (to be described later). In the description below, learning data for creating the cell central value learning table will be described as an example.

It is assumed that the learning data described here is provided on the N cell unit basis. The value of N is assumed to be less than the number of cells to which the inter-code interference influences a lot according to the cell length. It is apparent that, if the cell length is 160 nm, the central cell is influenced by the inter-code interference from the two cells which are of the preceding cell and the following cell, in consideration of an equalizer coefficient of waveform equalization shown in FIG. 27.

That is, fundamentally, the learning data needs to be recorded or reproduced by five cell unit to recognize the influence from the inter-code interference. By taking consideration of the amount of learning data, there are 512 combinations of consecutive three cells (1536 cells) in the case of a unit of three cells, while there are significantly large amount, such as 32768 combinations of consecutive five cells (163, 840 cells) in the case of a unit of five cells. Thus, the learning time increases accordingly.

The present invention uses the learning data of three cell unit even when the cell length is 160 nm and the inter-code interference from the two of the preceding cell and the following cell influences the central cell. A predetermined dummy cell data is inserted between pieces of the learning data of three cell unit for the purpose of averaging the influence caused by the inter-code interference from the two of the preceding cell and the following cell.

If the dummy cell data is at the level 0 and inserted between pieces of the learning data of the three cell unit, there are 512 combinations resulted from consecutive three cells and a piece of dummy cell data. By taking the learning data for creating the cell central value learning table as an example, the total number of pieces of the learning data is 1536 cells (512×3) when the dummy cell data is not inserted, while the total number is 2048 cells (512×4) when the dummy cell data is inserted. As the dummy cell data is for averaging influences caused by the inter-code interference, the level is not limited to the level 0 and may be the other level. The dummy cell data is not limited to the level itself and any information bit having somewhat width or area may be recorded only if it is for averaging the influence caused by the inter-code interference. The dummy cells may be serially continued by the number to such extent that the amount of learning data in the leaning area does not extremely increase, for example two.

With the abovementioned process, while the amount of data increases a little bit, while the amount is still significantly less than that in the case where the five cell unit is adopted. That process does not increase a time required for leaning and reproducing so much.

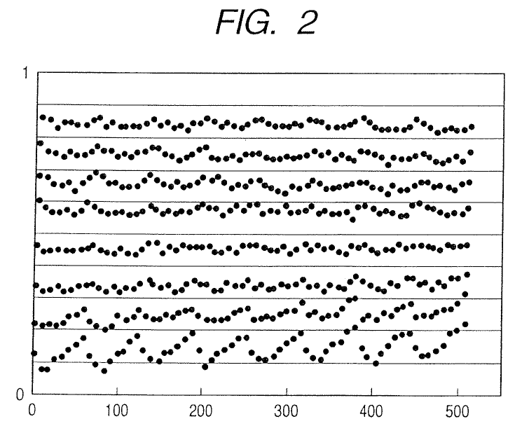

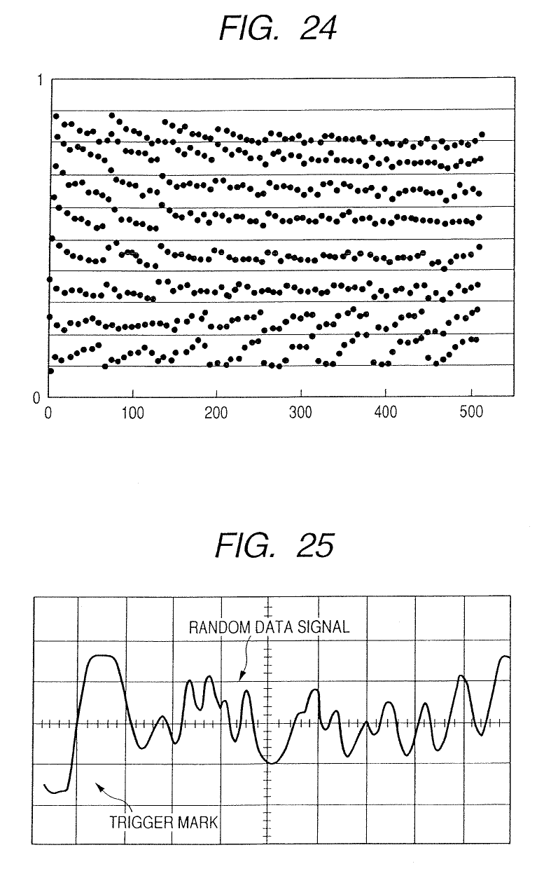

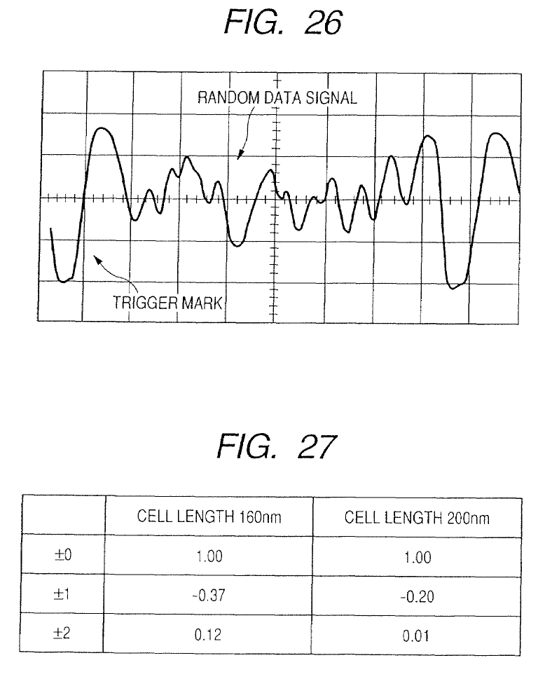

FIG. 2 is a learning table plotted in the case in which dummy cell data are inserted between the leaning data of the three units by assuming the dummy cell data is at the level 0. It is apparent that the learning table of FIG. 2 is closer to the ideal learning table obtained by the calculation than the learning table of FIG. 24. When the learning table is actually used for reproduction, a desired error rate can be obtained.

As described above, the present invention is arranged to perform, according to the cell length, recording and reproducing by inserting the dummy cell data of a predetermined level between the learning data of the N cell unit which is smaller than the number of cells to which the inter-code interference influences largely and level value pf which is previously known, thereby performing the learning such as the inter-code interference. In such a manner, the learning table close to an ideal learning table can be obtained without increasing the amount of the data so that highly accurate recording and reproducing of the multivalued information can be performed with the obtained learning table.

Although the N cell unit is described as three cell unit here, the present invention can be used even in the case in which storage capacity becomes more denser to make the number of cells to which the inter-code interference influences the seven cell unit. That is, by inserting the dummy cell data between the smaller number of the learning data, for example that of the five cell unit, the amount of learning data can be reduced so that highly accurate recording and reproducing can be performed on the multivalued information.

As an example of a method for reproducing multivalued information by using the learning table obtained by a learning method according to the present invention, a method for reproducing multivalued information by using both the cell central sample value and the sample value at the boundary of cells will be described.

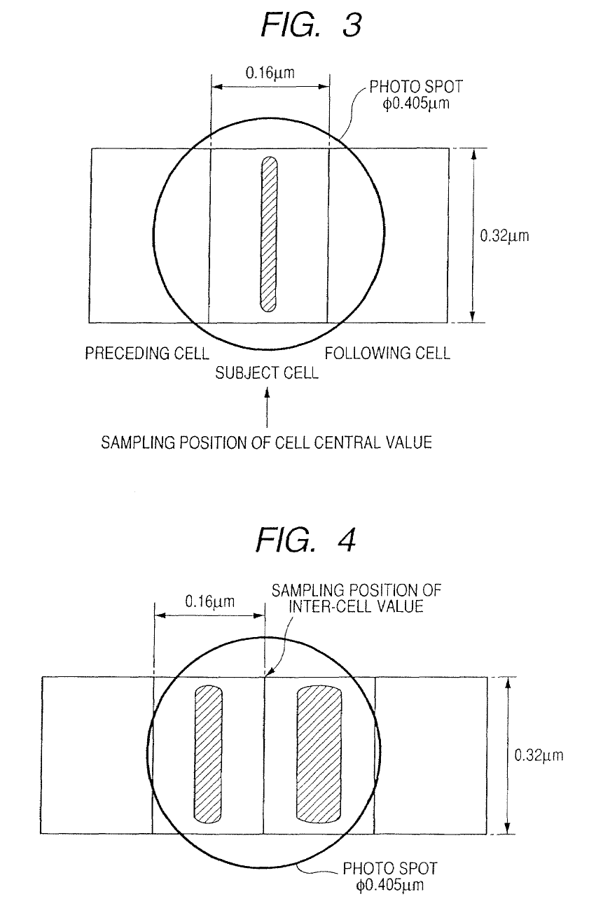

Now, a specific method for reproducing multivalued information will be described in detail. The method for reproducing the multivalued information is the same as that of the prior application. As described above, the cell central value/inter-cell value separation detecting circuit 12 separates the sampled digital signal into the cell central value and the inter-cell value and detects each of them. Here, differences between the sampling positions of the cell central value and the inter-cell value and feature of them will be described with reference to FIG. 3 and FIG. 4.

FIG. 3 shows physical relationship between preceding and following cells and a photo spot when a cell central value is sampled. It is assumed that the track pitch is 0.32 μm, the size of the photo spot is 0.405 μm (wavelength 405 nm, the numerical aperture of the object lens: NA 0.85), and the size of the cell is 0.16 μm. It is experimentally known that the cell central value of the subject cell does not take the same value since the levels of the preceding cell and the following cell change between 0 and 7 in the parameter, and has a width due to influence caused by the inter-code interference.

That is intuitively understood from the fact that the edges of the photo spot on the central cell in FIG. 3 are over the cells on the both sides. The influence caused by the inter-code interference on the cell central value increases as the cell decreases against the size of the photo spot.

FIG. 4 shows physical relationship as the photo spot is given on the boundary of the right and left two cells when an inter-cell value is sampled. The width of two cells is 0.32 μm against the size of the photo spot 0.405 μm, the inter-cell value that is sampled at the boundary between the left and right cells is slightly influenced from the outer side. The less influence caused by the inter-code interference from outer than the left and right cells is so small.

The above-described cell central value and the inter-cell value can be obtained when they are sampled at a clock in sync with the multivalued data which is generated by the PLL circuit 11, by the cell central value/inter-cell value separation detecting circuit 12. The clock for sampling the cell central value and the clock for sampling the inter-cell value are at the same frequency while with their phases are different only by ½ period (one cell is considered as one period).

Then, the waveform equalization is performed on reproduced signals of the cell central value and the inter-cell value by the cell central value waveform equalization circuit 13 and the inter-cell value waveform equalization circuit 14 respectively. First, the cell central value waveform equalization circuit 13 will be described. The inter-code interferences from the information pits written preceding to and following to the information pit is reduced with respect to the reproduced signal of the information pit concerned by the cell central value waveform equalization circuit 13.

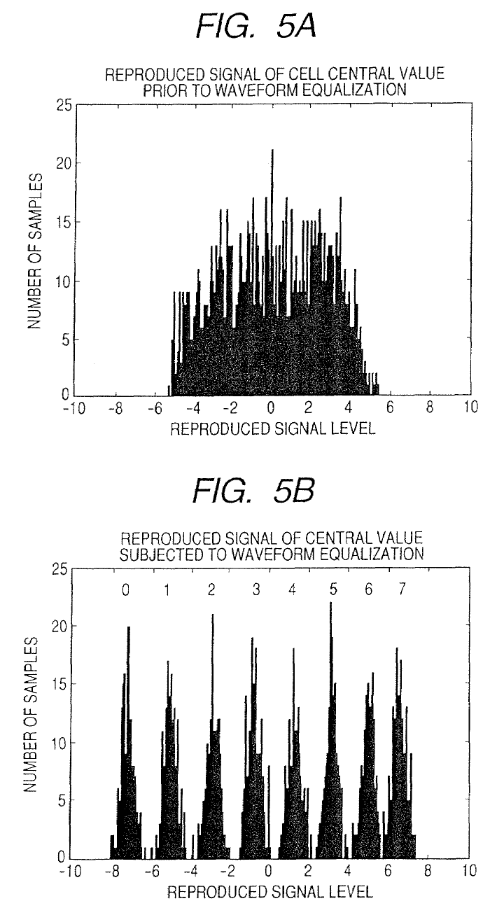

Here, as an example of showing an effect of reducing the inter-code interference will be described with reference to FIGS. 5A and 5B.

FIGS. 5A and 5B show simulation results showing histograms of the reproduced signal level of the cell central values before and after the waveform equalization in the case in which multivalued data of eight levels is reproduced by using the bluish-purple light source (405 nm) and the optical system of NA 0.85 and the size of a cell which is virtually provided for the optical disk whose track pitch is 0.32 μm, to record a piece of information pit is 0.2 μm. FIG. 5A shows reproduced signals of the cell central values before the waveform equalization. FIG. 5B shows reproduced signals of the cell central value after the waveform equalization. As it is apparent from FIGS. 5A and 5B, the reproduced signals are separated into levels from 0 to 7 by the waveform equalization so that they can be easily detected as multivalued data. Although the size of the cell is described as 0.2 μm in FIGS. 5A and 5B, it is considered that the same tendency appears even if the size of the cell is 0.16 μm.

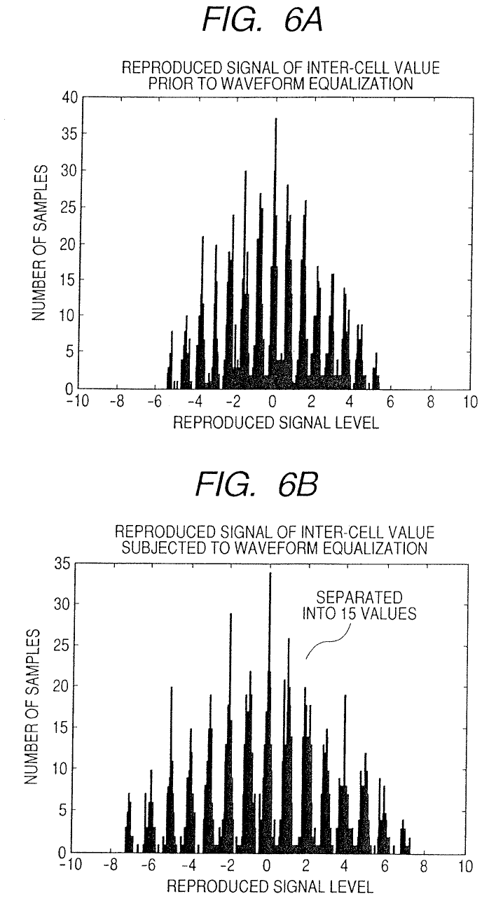

Next, the inter-cell value waveform equalization circuit 14 will be described. By the inter-cell value waveform equalization circuit 14, the inter-code interference from the information pit written outer than the left and right cells is reduced with respect to the inter-cell value on the boundary of the left and right cells. An example of an advantage for reducing the inter-code interference as in the case of the cell central value will be described with reference to FIGS. 6A and 6B.

FIGS. 6A and 6B show simulation results showing histograms of the reproduce signal level of the inter-cell value before and after the waveform equalization, which are calculated by using the same parameters as in the FIGS. 5A and 5B. FIG. 6A shows a reproduced signal of the inter-cell value before the waveform equalization and FIG. 6B shows a reproduced signal of the inter-cell value after the waveform equalization. As it is apparent from FIGS. 6A and 6B, the reproduced signals of inter-cell value are separated into the 15 values from 0 to 14 without being subjected to signal processing such as waveform equalization. It is a matter of course that the degree of separation can be further increased with waveform equalization. The reproduced signals are separated into the 15 values because if the sum of the multivalued level in two adjacent cells is the same, the inter-cell value takes the same level.

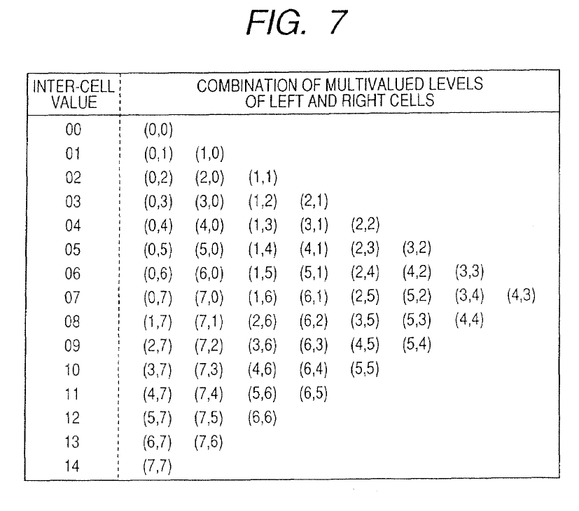

That is described with reference to FIG. 7. FIG. 7 is a diagram illustrating combinations of multivalued levels of cells arranged left and right to the inter-cell value. The combination of the left and right cells are 8×8=64 in total, however, the reproduced signal of the inter-cell value can take the values as the level thereof. That is, it is apparent that the sum of the multivalued level at left and right is the value for the inter-cell value.

Accordingly, if the multivalued level of the preceding cell is known, the level of the following cell can be uniquely as the inter-cell value are detected. Assuming that the level of the preceding cell is known as “3” and the inter-cell value can be detected as “value 7”, the level of the following cell can be determined as “4” as a result of 7−3=4. Assuming that the level of the preceding cell is “X” (0≦X≦7, where X is an integer), the level of the following cell is “Y” (0≦Y≦7, where Y is an integer) and the inter-cell value is “Z” (0≦Z≦14, where Y is an integer), X+Y=Z (or Z−X=Y).

After the waveform equalization is performed on the cell central value and the inter-cell value, the multivalued data discriminating circuit 15 outputs the multivalued data of the determination, and the multivalued-binary value converting circuit 16 converts the data and outputs it.

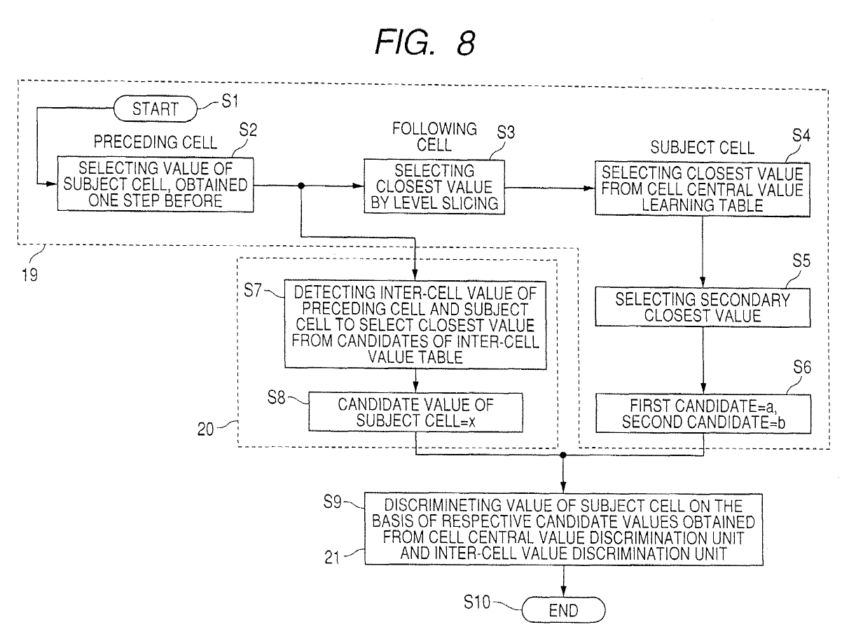

Now, a method for discriminating the multivalued data in the multivalued data discriminating circuit 15 will be described in detail with reference to FIG. 8 to FIG. 14. It is assumed that the multivalued data of the 8 values from 0 to 7 is reproduced. FIG. 8 is a diagram for illustrating a method for discriminating multivalued data in a multivalued data discriminating circuit 15. The multivalued data discriminating circuit 15 is mainly separated into the cell central value discriminating unit 19, the inter-cell value discriminating unit 20 and a final value discriminating unit 21.

First, the cell central value discriminating unit 19 will be described. The cell central value discriminating part 19 is for performing discrimination by taking account of three serial cells (a preceding cell, a subject cell, a following cell) as described in FIG. 3. When the reproduced signal of the cell central value is input, the multivalued data discriminating circuit 15 starts operation at step 1.

Then at step 2, the value of the preceding cell is decided (For this value, the value of the subject cell obtained at the previous step is selected). If the value of the subject cell discriminated at the previous step is “7”, the value for the preceding cell is selected as “7” (The term “select” here means provisional discrimination, instead of a final discrimination). Alternatively, as a method of selecting the value of the preceding cell, the reproduced signal of the cell central value (a sampling value when a photo spot is on the center of the preceding cell) may be level-sliced with a plurality of thresholds according to the respective levels and decided.

Next at step 3, the value of the following cell is selected (the closest value in the level slice is selected) by level-slicing the reproduced signal of the cell central value (a sampling value when a photo spot is on the center of the following cell). It is assumed that the value of the following cell is selected as “7”. The values of the preceding cell and the following cell are selected among the three serial cells so far.

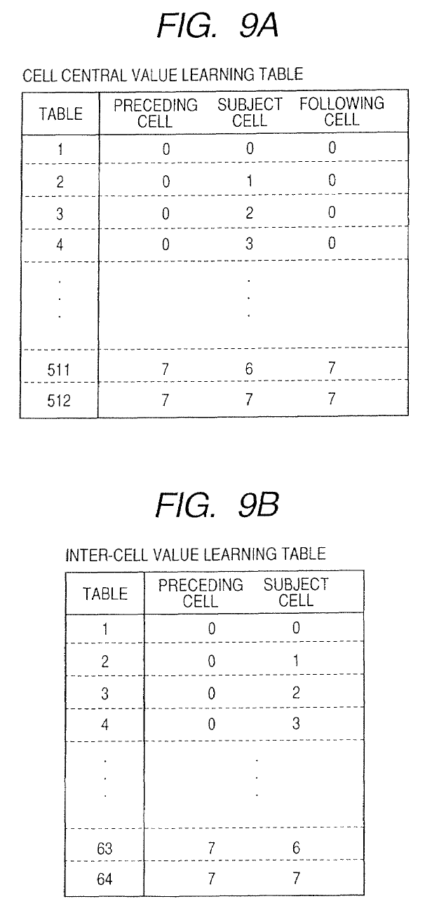

Then at step 4, the value of the subject cell closest to the reproduced signal of the cell central value is selected from the cell central value learning table (FIG. 9A and FIG. 9B) by using the value of the preceding cell and the following cell. At step 5, the second closest value is selected. At step 6, the values selected at steps 4 and 5 are decided as a first candidate “a” and a second candidate “b”.

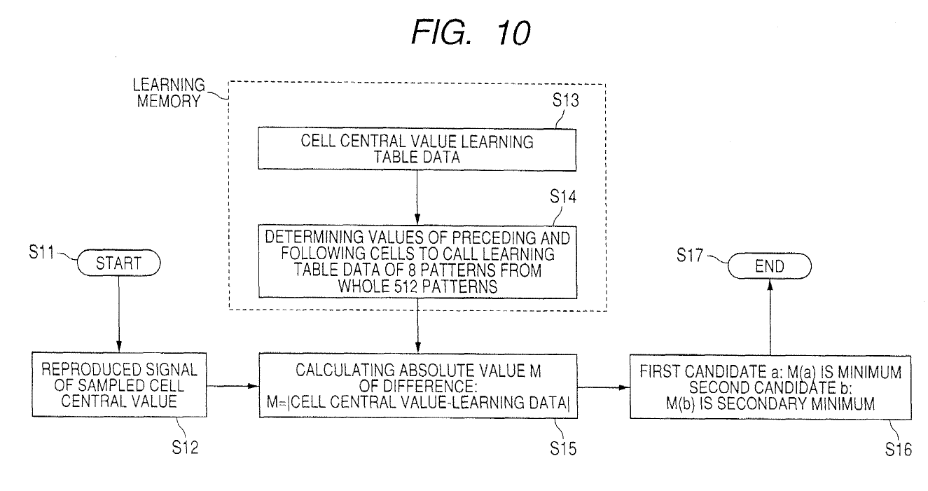

Steps 4 to 6 at the cell central value discriminating part 19 will be described in detail with referenced to FIGS. 9A and 9B and FIG. 10. FIGS. 9A and 9B show learning tables used for discriminating the multivalued data. FIG. 9A is the central value learning table, including 512 patterns of tables in total (8×8×8) corresponding to all combinations that can be taken by the preceding cell, the subject cell and the following cell.

The pieces of information of 512 patterns are recorded at the top of the user data area on the optical disk 1, and a reproduced signal of the cell central value of the subject cell in each pattern is detected before the information in the user data area is reproduced, so that the sampling value is stored in the leaning memory 17 as a reference value. In that case, the learning data of 512 patterns is stored by three cell unit and the dummy cell data at the level 0 is inserted between the three cell unit as mentioned above.

Next, a method of deciding a candidate value of the subject cell by using the cell central value table at steps 4 to 6 in the cell central value discriminating unit 19 shown in FIG. 8 will be described with reference to FIG. 10. First, the operation starts at step 11. At step 12, the sampled reproduced signal of the cell central value is input into the cell central value discriminating unit in order. At step 13, the learning memory 17 is accessed. At step 14, the reference value obtained from the cell central value leaning table shown in FIG. 9A is read out from the learning memory 17 in order each time when the cell central value is input.

Here, as the values of the preceding cell and the following cell are selected as “7” (see the description of FIG. 8), the tables to be read out are narrowed from 512 patterns in total to eight patterns, i.e., the combinations from (7, 0, 7) to (7, 7, 7). Next at step 15, the absolute value of a difference between the cell central value and the eight patterns of reference value is calculated and the result is made as the value M. At step 16, eight of the value M are compared with each other. Assuming that the value M (that is represented as M (a)) becomes the smallest when the value of the subject cell is “a”, “a” is decided as the first candidate in the cell central value discriminating part 19.

Assuming that the value M (that is represented as M (b)) becomes the second smallest when the value of the subject cell is “b”, “b” is decide as the second candidate in the cell central value discriminating part 19. Then the operation proceeds to step 17, and the operation ends. The cell central value discriminating part 19 has been described.

Now, returning to FIG. 8, a method of deciding the value of the subject cell in the inter-cell value discriminating unit 20 will be described in detail with reference to FIG. 9A and FIG. 9B. As shown in FIG. 8, at step 7, the inter-cell value discriminating unit 20 selects the value of the subject cell closest to the reproduced signal of the inter-cell value from the inter-cell value leaning table (FIGS. 9A and 9B) by using the value of the preceding cell decided at step 2. At step 8, the value selected at step 7 is decided as the candidate value “x”.

Steps 7 and 8 in the inter-cell value discriminating part 20 will be described in detail with reference to FIGS. 9A and 9B and FIG. 10. FIG. 9B is the inter-cell value learning table, including 64 patterns of tables in total (8×8), corresponding to all combinations that can be taken by the preceding cell, the subject cell and the following cell. The pieces of information of 64 patterns are recorded at the top of the user data area on the optical disk 1, and a reproduced signal of the inter-cell value of each pattern is detected before the information in the user data area is reproduced, so that the sampling value is stored in the leaning memory 17 as a reference value.

The present invention may be used for the learning data for creating the inter-cell value learning table. In such a case, the learning data of 64 patterns is recorded by the two cell unit and the abovementioned dummy cell data is inserted between the pieces of the learning data.

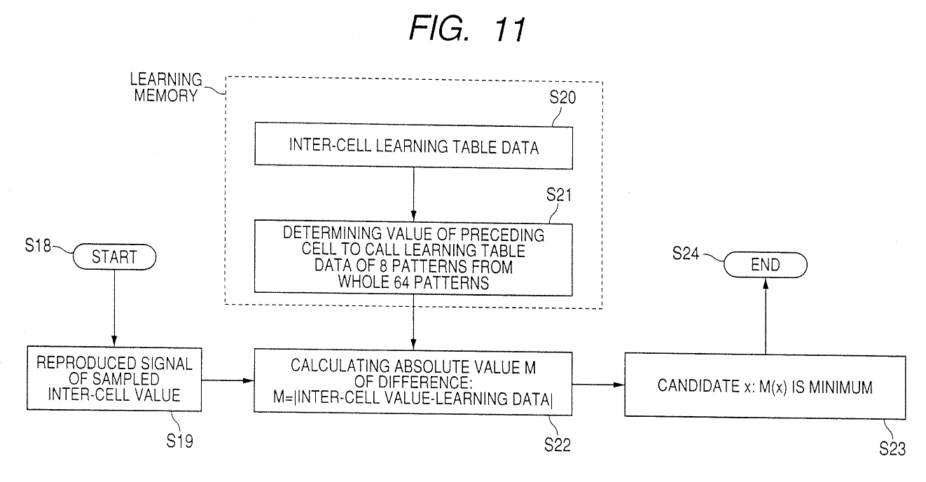

Next, a method of deciding a candidate value of the subject cell by using the inter-cell value learning table at steps 7 and 8 in the inter-cell discriminating unit 20 shown in FIG. 8 will be described with reference to FIG. 11. First, the operation starts at step 18. At step 19, the sampled reproduced signal of the cell central value is input into the inter-cell value discriminating unit 20 in order. At step 20, the learning memory 17 is accessed. At step 21, the reference value obtained from the inter-cell value leaning table shown in FIG. 9B is read out from the learning memory 17 in order each time when the inter-cell value is input.

Here, as the value of the preceding cell is selected as “7” (see the description of FIG. 8), the tables to be read out are narrowed from 64 patterns in total to eight patterns, i.e., the combinations from (7, 0) to (7, 7). Next at step 22, the absolute value of a difference between the inter-cell value and the eight patterns of reference value is calculated and the result is made as the value M. At step 23, eight of the value M are compared with each other. Assuming that the value M (that is represented as M(x)) becomes the smallest when the value of the subject cell is “x”, “x” is decided as a candidate value in the inter-cell value discriminating unit. Then the operation proceeds to step 24, and the operation ends. The inter-cell value discriminating unit 20 has been described.

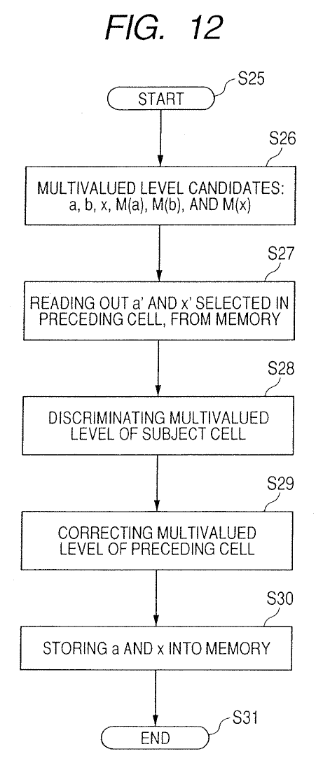

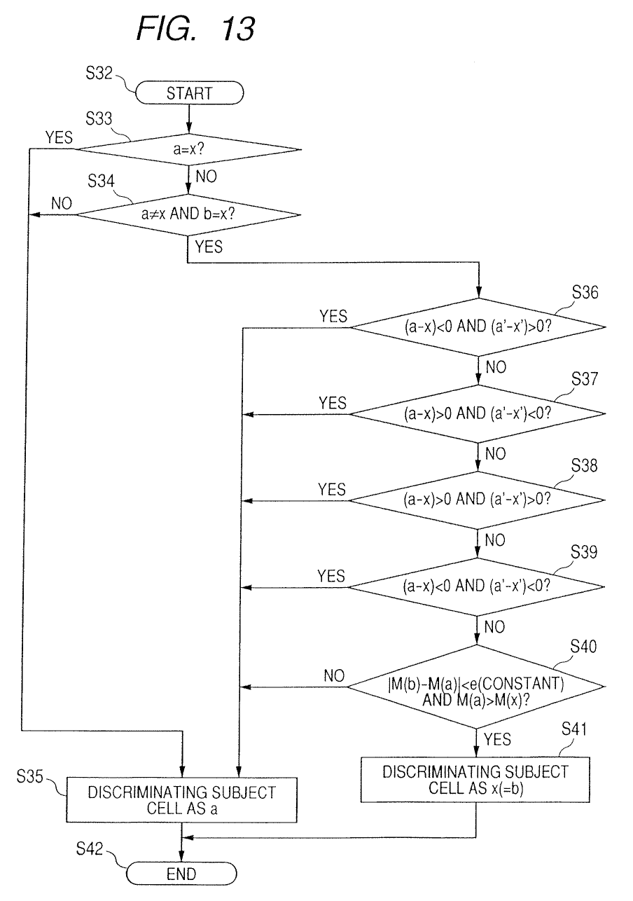

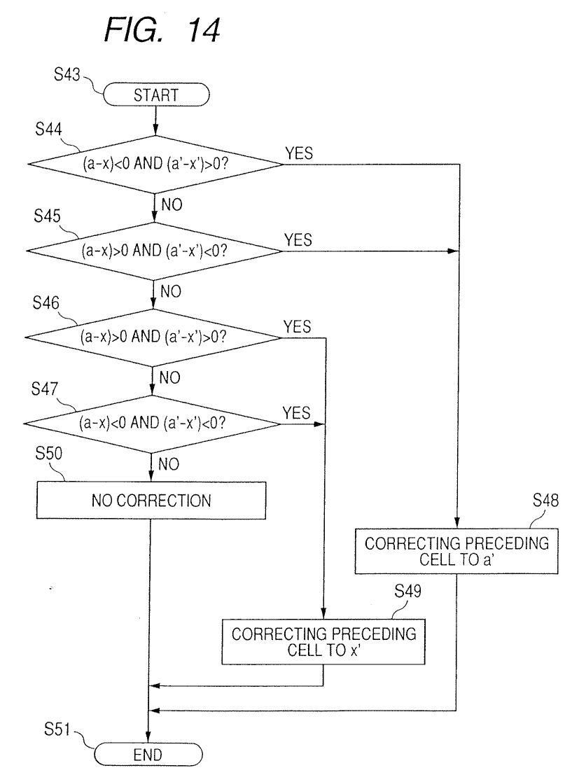

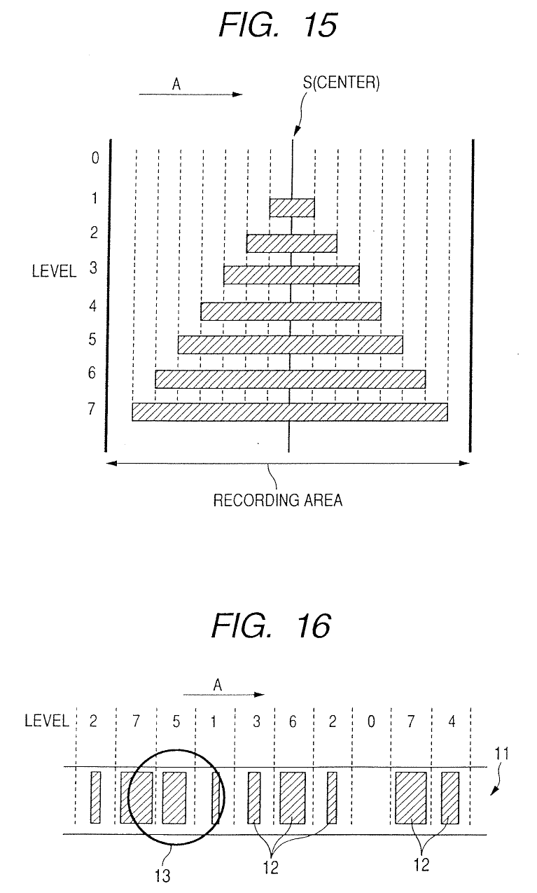

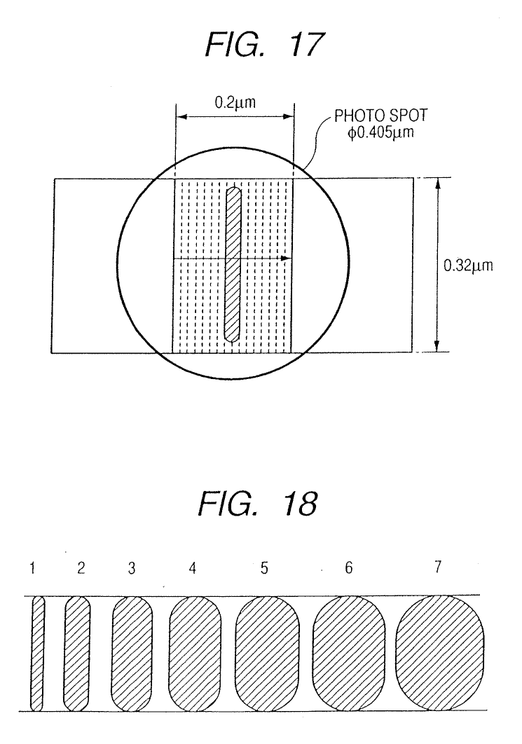

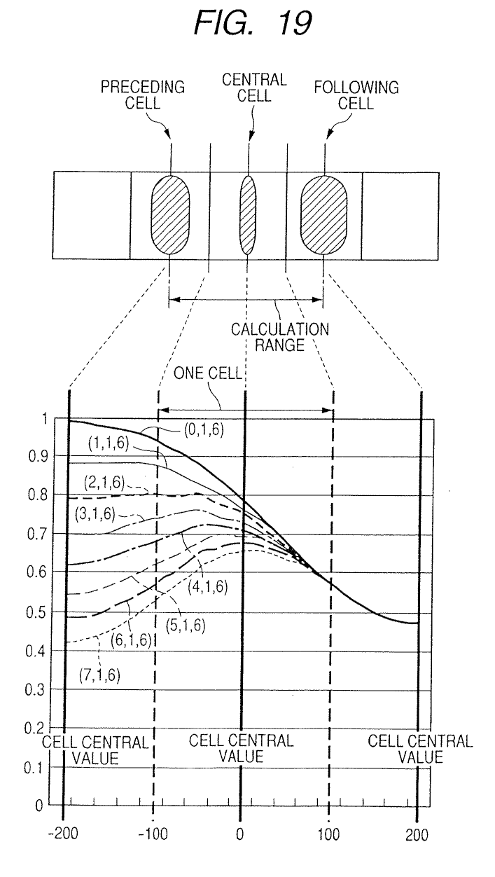

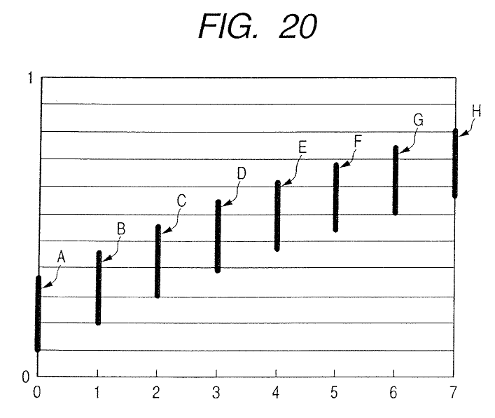

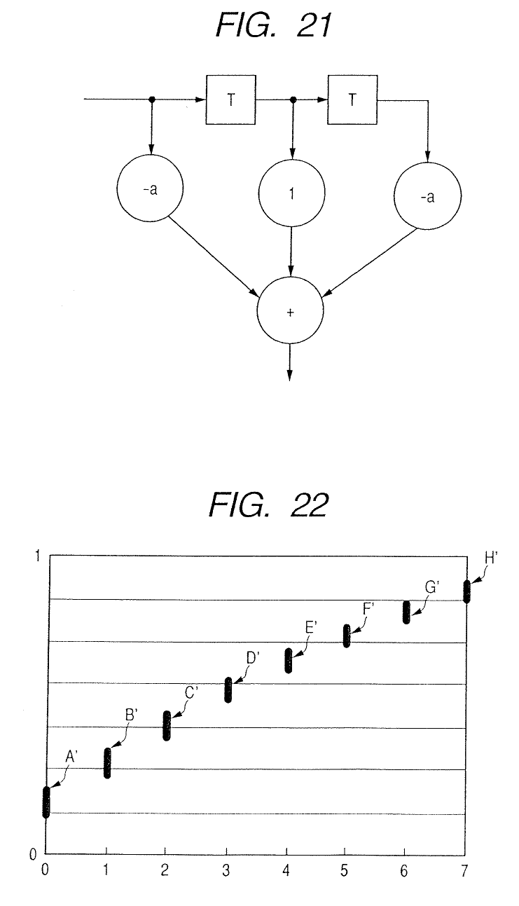

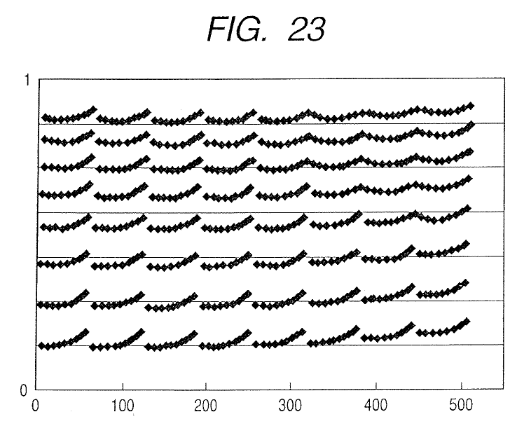

Returning to FIG. 8 again, the algorithm for the final value discriminating unit 21 that finally performs discrimination by using the candidate value obtained in the cell central value discriminating unit 19 and the inter-cell value discriminating unit 20 respectively will be described in detail with reference to FIG. 12, FIG. 13 and FIG. 14.

FIG. 12 shows a flow of processing operation in the final value discriminating unit 21. First, the operation starts at step 25. At step 26, “a”, “b” and “x”, which are candidates of the multivalued level, and M(a), M(b) and M(x), which are the value M corresponding respectively, are input. At step 27, “a′” and “x′”, which are candidate values selected at the preceding cell, are read out from the memory. “a′” and “x′” are “a” and “x” stored in the memory at step 30 to be described later before a series of final value discriminating operations at the previous step ends.

At step 28, the multivalued level of the subject cell is finally discriminated using those parameters, and then at step 29, the multivalued level of the preceding cell is corrected. At step 30, “a” and “x” are stored in the memory, then the operation proceeds to step 31 and the operation ends.

Now, the algorithm for finally discriminating the multivalued level of the subject cell at step 28 will be described in detail with reference to FIG. 13. At step 32, the operation starts. Next, the case in which a=x at step 33 will be considered. As the step has fairy high right answer ratio, the operation proceeds to step 35, where the value of the subject cell is discriminated as “a”, and the operation ends at step 42. Then the operation proceeds to step 34. The case in which a≠x and also b=x will be considered.

In this case, determination of whether the right answer is “a” or “x” is difficult, thus, the determination needs to be made in consideration of the other parameters. In the present invention, M(a), M(b) and M(x), which are the absolute value of a difference between candidates “a′” and “x′”, selected at the previous step in the preceding cell, and the reference value in the learning table is considered as the parameters.

Now, a method of discriminating in consideration of “a′” and “x′” at steps 36 to 39 will be described. The method intends to improve accuracy of discrimination of the subject cell by examining relationship between the candidate value in the preceding cell and the candidate value in the subject cell. That is, the method takes advantage that candidate values of the subject cell and the preceding cell necessarily have a certain rule if the determination in the preceding cell differs from the actual correct value. First, the case in which x′ is discriminated as the final value of the preceding cell by mistake will be considered.

In a case where the candidate value “a′” of the preceding cell is “3” and that of “x′” is “2”, assuming that the correct values of the preceding cell and the subject cell are “3”, and “2” of “x′” is wrongly selected as the final discriminated value, the probability is high in that, for the candidate of the subject cell, “a” is “3” and “x” is “4”. This is because that, assuming that the level of the preceding cell is “X” (0≦x≦7, where X is an integer), the level of the following cell is “Y” (0≦Y≦7, where Y is an integer) and the inter-cell value is “Z” (0≦Z≦14, where Z is an integer), relationship of X+Y=Z (or Z−X=Y) is established (in this case, Z=6) as mentioned above.

That can be described in a general formula of:

(a−x)<0, and (a′−x′)>0; step 36, or

(a−x)>0, and (a′−x′)<0; step 37.

If steps 36 and 37 are satisfied, “x” is highly possible to be wrong. Thus, the subject cell is finally discriminated as “a” at step 35 and the operation ends at step 42.

In contrast, now consider the case in which “a′” is wrongly discriminated as the final value of the preceding cell. Assuming the case in which the candidate value “a′” of the preceding cell is “4” and that of “x′” is “3”, the right values of the preceding cell and the subject cell are “3”, and “4” of “x′” is wrongly selected as the final discriminated value, the probability is high in that case that, for the candidate of the subject cell, “a” is “3” and “x” is “2”.

That can be described in a general formula of:

(a−x)>0, and (a′−x′)>0; step 38, or

(a−x)<0, and (a′−x′)<0; step 39.

If the conditions at steps 38 and 39 are satisfied, “x” is highly possible to be wrong. Thus, the subject cell is finally discriminated as “a” at step 35 and the operation ends at step 42. A determining method taking into consideration “a′” and “x′” has been described.

If none of conditions at steps 36 to 39 are matched, determination is made by taking consideration of M(a), M(b), and M(x) as a second method.

That is, if the conditions of |M(b)−M(a)|<e, and M(a)>M(x); step 40 are satisfied, the subject cell is finally discriminated as “x (=b)” at step 41. Here, “e” is a constant and it is preferably set as a value of ½ to ¼ of the level difference of the cell central value between respective multivalued levels.

That is, it implies that if the conditions of |M(b)−M(a)|<e are satisfied, it is quite difficult to discriminate whether it is “a”/or “b” from the reproduced signal of the cell central value. By ultimately considering the case of |M(b)−M(a)|=0, the probabilities that the subject cell is either “a” or “b” are 50% respectively. Therefore, if the conditions of M(a)>M(x) are satisfied, it is determined that the subject cell is highly possible to be “x (=b)” and the operation ends at step 42.

Finally, consider the case in which the conditions at steps 33 and 34 are not satisfied (a≠x, and b≠x). In this case, as “x” is highly possible to be wrong, the value of the subject cell is discriminated as “a” at step 35, and the operation ends at step 42. This is because that an error in reproduction is approximately within ±1 level is known from the simulation result (“a” or “b” is the right answer), and the probability that “x” is a correct answer is quite low.

Next, returning to FIG. 12, and after the multivalued level of the subject cell is finally discriminated at step 28, the multivalued level of the preceding cell is corrected at step 29.

FIG. 14 shows an algorithm for correcting the multivalued level of the precedence cell at step 29. First at step 43, the operation starts. Next, at steps 44 to 47, the finally discriminated value is corrected by examining the relationship between the candidate value in the preceding cell and the candidate value in the subject cell as described in FIG. 13.

That is, if the candidate values of the subject cell and the preceding cell have a rule, it is determined that the discriminated result in the preceding cell is different from an actual correct value. If the candidate value “a′” of the preceding cell is “3” and that of “x′” is “2”, assuming that the correct values of the preceding cell and the subject cell are “3”, and “2” of x′ is wrongly selected as the final discriminated value, then the probability is high in that, for the candidate of the subject cell, “a” is “3” and “x” is “4”.

That can be described in a general formula of:

(a−x)<0, and (a′−x′)>0; step 44, or

(a−x)>0, and (a′−x′)<0; step 45.

Therefore, if the conditions at steps 44 and 45 are satisfied, the operation proceeds to step 48 where the preceding cell is corrected to “a′” and the operation ends at step 51. In that case, it is concluded that discriminating the preceding cell as “2” of “x′” is wrong and it is corrected to “3” of “a”.

In contrast, the case in which “a′” is discriminated as the final value of the preceding cell will be considered. Assuming the case in which the candidate value “a′” of the preceding cell is “4” and that of “x′” is “3”, the right values of the preceding cell and the subject cell are “3”, and “4” of “a′” is wrongly selected as the final discriminated value, then the probability that, for the candidate of the subject cell, “a” is “3” and “x” is “2” is high in that case.

That can be described in a general formula of:

(a−x)>0, and (a′−x′)>0; step 46, or

(a−x)<0, and (a′−x′)<0; step 47.

If the conditions at steps 4 and 47 are satisfied, the operation proceeds to step 49 where the preceding cell is corrected to “x′” and the operation ends at step 51. In that case, it is concluded that discriminating the preceding cell as “4” of “a′” is wrong and it is corrected to “3” of “x′”.

The details of the final value discriminating part of FIG. 12 and a method of discriminating the multivalued data in the multivalued data discriminating circuit 15 have been described.

Although a data adding circuit for error correction for adding data for correcting an error on the input binary data and a synchronized signal adding circuit for adding a synchronized signal for indicating a separation of predetermined amount of data are not mentioned in the optical disk device according to the present invention as a postscript, it makes no difference to the principle of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-240259, filed on Sep. 5, 2006, which is hereby incorporated by reference herein in its entirety.

What is claimed is:

1. A multivalued information recording reproducing method of recording multivalued information by writing, by using a photo spot, an information pit on a virtual cell that is set on a track of an optical information recording medium, while changing a width of the information pit in the direction of the track, and of reproducing the multivalued information by detecting a level of the multistep reproduced signal from the information pit, comprising the steps of:
recording different pieces of multivalued information in a learning area of the optical information recording medium on a unit cell basis,
wherein the unit cell includes a predetermined number of cells and a predetermined information pit is recorded or otherwise none is recorded in cells at both ends of the predetermined number of cells;
sampling the reproduced signals of the multivalued information on the unit cell basis by using the photo spot;
storing the reproduced signals in the sampled learning area on the unit cell basis;
recording the multivalued information in a user data area of the optical information recording medium;
sampling, by using the photo spots, the reproduced signals from the multivalued information recorded on the user data area; and
reproducing the multivalued information in the user data area by comparing the reproducing signal of the learning area and the reproduced signal of the user data area.

2. A method according to claim 1, wherein the reproduced signal of the multivalued information in the learning area and the reproduced signal of the multivalued information in the user data area are sampled when the center of the photo spot arrives at the center of the cell.

3. A method according to claim 1, wherein the reproduced signal of the multivalued information in the learning area and the reproduced signal of the multivalued information in the user data area are sampled when the center of the photo spot arrives at the boundary between the cell and a cell following to the cell.

4. A method according to claim 1, wherein the reproduced signal of the multivalued information in the learning area and the reproduced signal of the multivalued information in the user data area are sampled when the center of the photo spot arrives at the center of the cell and at the boundary between the cell and a cell following to the cell.

5. A method according to claim 1, wherein the photo spot is made up with a bluish-purple semiconductor laser and an object lens of the numerical aperture NA 0.85 and the length of the cell is 160 nm or less.
